(19) United States
(12) Patent Application Publication
(10) Pub. No.: US 2001/0026867 A1
(43) Pub. Date: Oct. 4, 2001

(54) Thermoforming mold, thermoformed article and process for producing same, and laminated molding article and process for producing same

(76) Inventors: Tsuyoshi Kayanoki, Mino-shi (JP); Kenichi Higashi, Sodegaura-shi (JP); Yoshiaki Togawa, Kyoto-shi (JP)

Correspondence Address: SUGHRUE, MION, ZINN,, MACPEAK & SEAS, PLLC, 2100 PENNSYLVANIA AVENUE, N.W., WASHINGTON, DC, 20037, US

(21) Appl. No.: 09/739,642

(22) Filed: Dec. 20, 2000

(30) Foreign Application Priority Data
Dec. 27, 1999 (JP) 11-370678

(51) Int. Cl. B32B 7/02; B29C 51/10; B29C 45/14; C08F 110/06; B29D 9/00

(52) U.S. Cl. 428/213; 264/510; 264/544; 264/553; 264/259; 425/388; 425/403; 428/500; 526/348; 526/351

(57) ABSTRACT

There Is provided: (1) a thermoforming mold having a surface roughness (Ra) of not more than 0.1 μm;

(2) a thermoformed article comprising a crystalline olefin resin, which article has a surface roughness (Ra) of not more than 3μm;

(3) a process for producing a thermoformed article, which comprises the steps of:

(i) heating and softening a crystalline olefin resin to obtain a sheet thereof; and

(ii) thermoforming the sheet with a thermoforming mold having a surface roughness (Ra) of not more than 0.3 μm to obtain a thermoformed article having a surface roughness (Ra) of not more than 3μm;

(4) a laminated molding article, which comprises:

(i) the above thermoformed article; and

(ii) a substrate containing a crystalline olefin resin; and

(5) a process for producing a laminated molding article.

### FIELD OF THE INVENTION

The present invention relates to a thermoforming mold, a thermoformed article and a process for producing same, and a laminated molding article and a process for producing same.

### BACKGROUND OF THE INVENTION

As a process for decorating a resin molded article, there is known a process comprising the steps of:

(1) obtaining a decorated sheet or film made of polymethyl methacrylate resin;

(2) thermoforming the sheet with a thermoforming mold to obtain a thermoformed article;

(3) setting the thermoformed article on a cavity side of a mold; and

(4) Injecting a molten resin for a substrate into the mold to obtain a laminated molding article, which contains the injected resin as a substrate and the thermoformed article bonded with the substrate.

In the present invention, the term, “sheet or film”, is hereinafter referred to as “sheet” for brevity. In the above process, a decorated thermoformed article in a sheet form is laminated by bonding on a surface of the resin molded article as a substrate. Here, the phrase, “decorated themnoformed article in a sheet form”, means (i) a thermoformed article in a sheet form which is superior in its surface glossiness, and (ii) a thermoformed article in a sheet form which is colored or printed.

In a known process such as the above-mentioned known process, a thermoformed article made of polymethyl methacrylate resin has been extensively used in order to satisfy both surface glossiness and scratch resistance of a laminated molding article obtained. From a viewpoint of cost and environmental protection, namely reduction of waste materials, it is desired to replace the thermoformed article made of polymethyl methacrylate resin by a thermoformed article made of a crystalline olefin resin, which olefin resin is low in cost and superior in recyclablity.

However, when the above-mentioned process is carried out using a crystalline olefin resin in place of polymethyl methacrylate, a thermoformed article obtained in step (2) has an insufficient surface glossiness, which is caused by whitening and coarse surface thereof. As a result, a laminated molding article obtained using said thermoformed article also results in an unsatisfactory quality (refer to JP-B 60-13815 and JP-B 60-30537).

### SUMMARY OF THE INVENTION

It is an object of the present invention to provide a thermoforming mold, which is capable of giving a thermoformed article having a superior surface appearance and recyclability. Here, the phrase, “thermoformed article having a superior surface appearance”, means (i) a thermoformed article having a superior surface glossiness, and (ii) a thermoformed article exhibiting a color or print having deep appearance, when said thermoformed article is colored or printed.

It is another object of the present invention to provide such a thermoformed article and a process for producing said thermoformed article.

It is a further object of the present invention to provide a laminated molding article comprising such a thermoformed article as an outermost layer, and a process for producing said laminated molding article.

The present inventors have undertaken extensive studies to accomplish the above-mentioned objects. As a result, it has been found that a thermoforming mold having a surface roughness (Ra) of not more than 0.1μm can give a thermoformed article having a superior surface appearance, and thereby the present invention has been obtained.

The present invention provides a thermoforming mold having a surface roughness (Ra) of not more than 0.1μm.

Further, the present invention provides a thermoformed article comprising a crystalline olefin resin, which article has a surface roughness (Ra) of not more than 3μm.

Still further, the present intention provides a process for producing a thermoformed article, which comprises the steps of:

(i) heating and softening a crystalline olefin resin to obtain a sheet thereof: and

(ii) thermoforming the sheet with a thermoforming mold having a surface roughness (Ra) of not more than 0.1μm to obtain a thermoformed article having a surface roughness (Ra) of not more than 3μm.

Additionally, the present invention provides a laminated molding article, which comprises:

(i) a thermoformed article containing a crystalline olefin resin, and having a surface roughness (Ra) of not more than 3μm; and

(ii) a substrate containing a crystalline olefin resin.

Still additionally, the present invention provides a process for producing a laminated molding article, which comprises the steps of:

(i) heating and softening a crystalline olefin resin to obtain a sheet thereof;

(ii) thermoforming the sheet with a thermoforming mold having a surface roughness (Ra) of not more than 0.1μm to obtain a thermoformed article having a surface roughness (Ra) of not more than 3μm;

(iii) setting the thermoformed article on a cavity side of a mold: and

(iv) injecting a molten crystalline olefin resin into the mold to obtain a laminated molding article, which contains the injected resin as a substrate and the thermoformed article bonded with the substrate.

### DETAILED DESCRIPTION OF THE INVENTION

The thermoforming mold in accordance with the present invention has a surface roughness (Ra) of not more than 0.1μm, preferably not more than 0.08μm, and more preferably not more than 0.06μm. The phrase, “surface roughness”, used in the present invention means a central line average roughness, Ra, measured according to JIS B0601 with use of a microscope for surface measurement, type VF-7500, manufactured by KEYENCE CORPORATION.

The thermoforming mold in accordance with the present invention is not limited in its form and its preparation method. For example, the thermoforming mold can be easily prepared by covering a surface of a known thermoforming mold, which known mold is made from a metal or a thermosetting resin such as an epoxy resin, with an aluminum sheet having a surface roughness of not more than 0.1μm and a thickness of 300μm with the aid of a double bond adhesive tape, wherein the known mold has a surface roughness of more than 0.1μm, and the known mold may be either an existing mold or a newly prepared mold. As the aluminum sheet, for example, a conventional aluminum sheet, which is usually used for press molding of a resin, can be used.

The “crystalline olefin resin” used for producing the thermoformed article in accordance with the present invention means a crystalline homopolymer of an olefin, or a crystalline copolymer of two or more olefin. The olefin is not limited in its kind. Preferred olefin are those having 2 to 10 carbon atoms. Examples of the olefin resin are a homopolymer of ethylene, a homopolymer of propylene, a homopolymer of 1-butene, a propylene/ethylene copolymer and a propylenel/1-butene copolymer. Preferred olefin resins are homopolymer of propylene and a copolymer of propylene with t least one olefin having 2 to 10 carbon atoms other than ropylene, such as a propylene/ethylene copolymer and a propylenel/1-butene copolymer. Preferred copolymers are a random copolymer and a block copolymer. Both of said preferred copolymers comprise 60 to 99% by weight of a structure unit derived from propylene, which unit is hereinafter referred to as “propylene unit”, and 40 to 1% by weight of a structure unit derived from an olefin other than propylene, which unit is hereinafter referred to as “olefin unit”. Of these, a more preferred olefin resin is a propylene homopolymer having an mmmm pentad % of preferably not less than 0.95, and more preferably not less than 0.97. The above-mentioned block copolymer can be produced according to a process described in, for example, JP-A 61-218606.

If desired, the above-mentioned crystalline olefin resin may be used in combination with a suitable amount of various additives usually used in the present field such as nucleating agents, antioxidants, ultraviolet ray absorbers and flame retarding agents.

A surface roughness (Ra) of the thermoformed article in accordance with the present invention is not more than 3μm, preferably not more than 2μm, more preferably not more than 1μm, and most preferably not more than 0.05μm. A thickness of the thermoformed article is preferably from 50 to 700μm, and more preferably from 50 to 300μm, from a viewpoint of easiness of cooling of the thermoformed article. The thermoformed article in accordance with the present invention has such a small surface roughness, namely, a superior surface smoothness, that it has a superior surface glossiness.

The thermoformed article in accordance with the present invention may have one layer or two or more layers. For example, when a two layered thermoformed article comprising a transparent layer and a printed or colored layer is used in order to produce a laminated molding article so as to arrange said transparent layer as an outmost layer, the obtained laminated molding article can exhibit not only a superior surface glossiness but also a print or color having deep appearance, wherein the printed layer or the colored layer in the laminated molding article is protected by the transparent layer of the outermost layer. Such a laminated molding article will be explained hereinafter.

A total haze of the thermoformed article in accordance with the present invention is preferably not more than 5%, and more preferably not more than 4%. An inner haze of the thermoformed article is preferably not more than 3%, and more preferably not more than 2.5%. The thermoformed article having both the total haze and inner haze within the range defined above can give a more superior surface glossiness and a deeper appearance to a laminated molding article in accordance with the present invention. Additionally, when the above-mentioned two layered thermoformed article is used, the transparent layer having both the total haze and inner haze within the range defined above can give a more superior surface glossiness and a print or color having deeper appearance to a laminated molding article in accordance with the present invention.

The thermoformed article in accordance with the present invention can be produced by a process comprising, for example, the steps of:

(i) heating and softening the crystalline olefin resin to obtain a sheet thereof: and

(ii) thermoforming the sheet with a thermoforming mold having a surface roughness (Ra) of not more than 0.1μm to obtain a thermoformed article having a surface roughness (Ra) of not more than 3μm.

The above step (i) can be carried out, for example, by contacting a molten product of the crystalline olefin resin extruded from a T die with a flat surface such as a surface of a roll or a belt, which has a surface roughness of not more than 2μm, and preferably not more than 0.4μm. The non-stretched sheet obtained in the step (i) can be used in the next step (ii).

A temperature of the sheet thermoformed in the above step (ii) usually ranges from a temperature lower by 20° C. than a melting point of the crystalline olefin resin to a temperature higher by 10° C. than the melting point of the crystalline olefin resin, preferably from a temperature lower by 15° C. than said melting point to a temperature higher by 5° C. than said melting point, and more preferably from a temperature lower by 15° C. than said melting point to the melting point of the crystalline olefin resin. In the step (ii) . it is preferable to cool quickly the sheet of the crystalline olefin resin after its thermoforming. In order to cool the sheet quickly, it is preferable to keep a temperature of the thermoforming mold from 10 to 80° C., and preferably from 20 to 30° C. Further, in order to carry out the quick cooling, it is preferable to bring the thermoformed article formed into a desired shape into contact with a fluid such as air and water of a low temperature as 10 to 20° C.

The thermoforming can be carried out according to, for example, a vacuum molding method, a press molding method, a vacuum press molding method or a plug assist molding method. Of these, a vacuum press molding method is preferred.

The laminated molding article according to the present invention comprises the above-mentioned thermoformed article and a substrate containing a crystalline olefin resin. Here, the “crystalline olefin resin” used for the substrate means the same crystalline olefin resin as that used for the production of the thermoformed article. Preferred resins used for the substrate are those capable of adhering easily to the thermoformed article. More preferred resins are those capable of melt-adhering to the thermoformed article. From a viewpoint of easy adhesion of the thermoformed article to the substrate, it is particularly preferred that the resin used for the thermoformed article is the same as or similar to that used for the substrate.

A laminated molding article in accordance with the present invention can be produced by a process comprising, for example, the steps:

(i) heating and softening a crystalline olefin resin to obtain a sheet thereof;

(ii) thermoforming the sheet with a thermoforming mold having a surface roughness (Ra) of not more than 0.1μm to obtain a thermoformed article having a surface roughness (Ra) of not more than 3μm;

(iii) setting the thermoformed article on a cavity side of a mold; and

(iv) injecting a molten crystalline olefin resin into the mold to obtain a laminated molding article, which contains the injected resin as a substrate and the thermoformed article bonded with the substrate.

In view of the objects of the present invention, the thermoformead article in the step (iii) must be set so that its surface having a surface roughness (Ra) of not more than 3μm becomes a surface of the laminated molding article obtained.

A molding method in the step (iv) may be, for example, an injection molding method, an injection compression molding method and an injection press molding method. A temperature of the resin injected in the step (iv) is usually not lower than a melting point thereof, and preferably not lower than 200° C. A temperature of the mold in the step (iv) is usually from 20 to 60° C. and preferably from 30 to 40° C. A surface of the mold is preferably even, and a surface roughness (Ra) thereof is preferably not more than 0.1μm. more preferably not more than 0.08μm, and much more preferably not more than 0.06μm.

The laminated molding article in accordance with the present invention, especially the laminated molding article comprising (i) a multi-layered thermoformed article containing a decorated sheet such as a colored sheet, a grained sheet, a metallic sheet and a carbon sheet, and (ii) a substrate, can be used particularly suitably for car parts such as a center cluster.

### EXAMPLES

The present invention is illustrated with reference to Examples, which are not to be construed as limiting the scope of the present invention. Evaluation methods are as follows.

1. Surface Roughness

A central line average roughness, Ra, was measured according to JIS B0601 using a microscope for surface measurement, type VF-7500, manufactured by KEYMNCE CORPORATION.

2. Glossiness

Visually measured. Glossiness when recognized is marked with ◯ and when not recognized is marked with X.

3. Haze

According to JIS K7105, a total haze and an inner haze were measured.

4. Whiteness

According to JIS L0803, a value of “L X a X b” was measured.

### EXAMPLE 1

Using an extruder, a mixture of 100 parts by weight of a propylene homopolyner and 0.3 part by weight of a nucleating agent was extruded at 210° C. through a coat hanger die having a lip aperture of 0.4 mm, thereby obtaining a film-like product. The film-like product was continuously contacted with a surface of a steel made specular belt having a surface roughness (Ra) of 0.4μm, which belt was kept at a temperature of 120° C., thereby performing solidification. The solidified film-like product was continuously drawn at a speed of 8 m/min., thereby obtaining a sheet having a thickness of 0.224 mm, a total haze of 3.2%, an inner haze of 2.5% and a surface roughness (Ra) of 0.03μm. In the above, as the propylene homopolymer, a polymer having a specific viscosity of 1.6 dl/g, a melt flow rate (MFR) of 8.0 g/10 min., a melting point of 168° C., a 23° C. flexural modulus of 1600 MPa and an mmmm pentad % of 0. 97, manufactured by Sumitomo Chemical Co., Ltd. was used. As the nucleating agent, sodium 2,2-methylenebis(4,6-di-t-butylphenyl)phosphate, a trade mark of ADK STB NA-21, manufactured by Asahi Denka Kogyo K. K. was used.

The sheet obtained was softened at its surface temperature of 153° C. using an infrared heater. The surface temperature is hereinafter referred to as sheet temperature. The sheet softened was brought into contact with a surface of a box form thermoforming mold, which surface was kept at 24° C. Immediately after the contact, a cold wind of 15° C. was blown to the sheet. Whereby, the sheet was thermoformed into a box form article. Results are as shown in Tables 1 and 2. The surface roughness and the glossiness shown in Table 2 are those of the surface of the thermoformed article obtained, which surface was subjected to contact with the mold. Here, the thermoforming mold used was prepared by covering a surface of a thermosetting resin made box with an aluminum sheet having a thickness of 300μm. Said thermoforming mold had a size of 180 mm X 125 mm X 40mm in box form, and a surface roughness (Ra) of 0.06μm.

### EXAMPLE 2

Example 1 was repeated, except that the sheet temperature was changed to 171° C., and no cold wind was blown, thereby obtaining a thermoformed article. The results are as shown in Tables 1 and 2.

### EXAMPLE 3

Example 1 was repeated, except that the sheet temperature was changed to 176° C., the surface temperature of the thermoforming mold was changed to 34° C., and no cold wind was blown, thereby obtaining a thermoformed article. The results are as shown in Tables 1 and 2.

### EXAMPLE 4

Example 1 was repeated, except that the sheet temperature was changed to 157° C., the surface temperature of the thermoforming mold was changed to 50° C., and no cold wind was blown, thereby obtaining a thermoformed article, The results are as shown in Tables 1 and 2.

### EXAMPLE 5

Example 1 was repeated, except that the sheet temperature was changed to 172° C., the surface temperature of the thermoforming mold was changed to 80° C., and no cold wind was blown, thereby obtaining a thermoformed article. The results are as shown in Tables 1 and 2.

Comparative Example 1

Example 1 was repeated, except that a themoforming mold having a surface roughness (Ra) of 32.0μm was used, thereby obtaining a thermoformed article. The results are as shown in Tables 1 and 2.

Comparative Example 2

Example 1 was repeated, except that a thermoforming mold having a surface roughness (Ra) of 32.0μm was used, the sheet temperature was changed to 171° C., the surface temperature of the thermoforming mold was changed to 25° C., and no cold wind was blown, thereby obtaining a thermoformed article. The results are as shown in Tables 1 and 2.

Comparative Example 3

Example 1 was repeated, except that a thermoforming mold having a surface roughness (Ra) of 32.0μm was used, the sheet temperature was changed to 176° C., the surface temperature of the thermoforming mold was changed to 50° C., and no cold wind was blown, thereby obtaining a thermoformed article. The results are as shown in Tables 1 and 2.

Comparative Example 4

Example 1 was repeated, except that a thermoforming mold having a surface roughness (Ra) of 32.0μm was used, the sheet temperature was changed to 157° C., the surface temperature of the thermoforming mold was changed to 85° C., and no cold wind was blown, thereby obtaining a thermoformed article. The results are as shown in Tables 1 and 2.

Comparative Example 5

Example 1 was repeated, except that a thermoforming mold having a surface roughness (Ra) of 32.0μm was used, the sheet temperature was changed to 172° C. the surface temperature of the thermoforming mold was changed to 85° C., and no cold wind was blown, thereby obtaining a thermoformed article. The results are as shown in Tables 1 and 2.

### EXAMPLE 6

The same mixture of the propylene homopolymer and the nucleating agent as that used in Example 1 was extruded in the same manner as in Example 1, thereby obtaining a transparent sheet having a thickness of 0.12 mm.

On the other hand, a propylene homopolymer having an MFR of 0 5 g/10 min., a trade mark of Sumitomo Noblen FH1016, manufacture by Sumitomo Chemical CO., Ltd., which was colored black, was extruded in a manner similar to that of Example 1, thereby obtaining a black sheet having a thickness of 0. 23 mm.

The above transparent sheet and the above black sheet, which black sheet was coated in advance with an adhesive of chlorinated polypropylene, were bonded with each other through pressing for 5 minutes at 100° C. under pressure of 5 MPa, thereby obtaining a two layered sheet. The obtained two layered sheet was found to have a whiteness measured at the transparent layer side of 8.65, and a surface roughness (Ra) measured at the transparent side of 0.04μm.

In a manner similar to that of Example 1, the above two layered sheet was softened through heating at 163° C., the transparent layer side thereof was brought into contact witb a surface of the thermoforming mold kept at its surface temperature of 30° C., and immediately after the contact, a cold wind of 15° C. was blown thereto, whereby the sheet was thermoformed into a box form article. As shown in Table 3, the thermoformed article was recognized to have glossiness. A whiteness of said thermoformed article measured on its transparent layer side was found to be 7.14, and a surface roughness thereof measured on its transparent layer side was found to be 0.03μm.

The black layer side of the thermoformed article was closely faced and fixed to a wall surface of an injection molding mold having a shape almost the same as that of the thermoformed article, which wall surface had a surface roughness of 0.06μm. Thereafter, the mold was closed, and a propylene polymer composition was injected into a space formed between the thermoformed article and the wall surface of the mold to obtain a laminated molding article having the propylene polymer layer, the black sheet and the transparent sheet in this order. The above mentioned propylene polymer composition was obtained according to Example 1 of JP-A 11-29690, which had an MFR of 30 g/10 min. and a 23° C. flexural modulus of 2400 MPa. The molding machine used for the above-mentioned injection was an injection molding machine, a trade mark of FS160S25ASEN, manufactured by Nissei Plastic Industrial Co., Ltd. A temperature of the above propylene polymer composition at the time of injection molding was 220° C., and a mold temperature was 40° C. A surface roughness of the laminated molding article obtained, glossiness thereof and a whiteness thereof are as shown in Table 3.

Comparative Example 6

Example 6 was repeated, except that the sheet temperature of the two layered sheet was changed to 177° C., and a thermoforming mold having a surface roughness of 32.0μm was used, thereby obtaining a laminated molding article. Results are as shown in Table 3.

TABLE 1

| | Thermoforming conditions | | | |
|---|---|---|---|---|
| | | Mold | | |
| | Sheet temperature(° C.) | Surface roughness(Ra: μm) | Suface temperature(° C.) | Cooling blow |
| Example 1 | 153 | 0.06 | 24 | yes |
| Example 2 | 171 | 0.06 | 25 | no |
| Example 3 | 176 | 0.06 | 34 | no |
| Example 4 | 157 | 0.06 | 50 | no |
| Example 5 | 172 | 0.06 | 80 | no |
| Comparative Example 1 | 153 | 32.0 | 24 | yes |
| Comparative Example 2 | 171 | 32.0 | 25 | no |
| Comparative Example 3 | 176 | 32.0 | 50 | no |
| Comparative Example 4 | 157 | 32.0 | 85 | no |
| Comparative Example 5 | 172 | 32.0 | 85 | no |

TABLE 2

| | Thermoformed article | | | | |
|---|---|---|---|---|---|
| | | | Haze (%) | | |
| | Surface roughness(Ra: μm) | Glossiness | Total haze | Inner haze | Thickness(μm) |
| Example 1 | 0.03 | ◯ | 3.4 | 1.6 | 193 |
| Example 2 | 0.03 | ◯ | 3.4 | 1.7 | 188 |
| Example 3 | 0.04 | ◯ | 3.4 | 1.5 | 180 |
| Example 4 | 0.04 | ◯ | 3.6 | 1.7 | 175 |
| Example 5 | 0.04 | ◯ | 3.7 | 1.9 | 181 |
| Comparative Example 1 | 3.4 | X | 7.0 | 1.7 | 182 |
| Comparative Example 2 | 7.3 | X | 11.7 | 1.2 | 179 |
| Compaxalive Example 3 | 9.2 | X | 12.3 | 2.1 | 196 |
| Comparative Example 4 | 18.3 | X | 20.1 | 2.1 | 170 |
| Comparative Example 5 | 28.3 | X | 30.2 | 3.2 | 184 |

TABLE 3

| | Thermoformed article | | | Laminated molding article | | |
|---|---|---|---|---|---|---|
| | | Surface roughness | | | Surface roughness | |
| | Whiteness | (Ra: μm) | Glossiness | Whiteness | (Ra: μm) | Glossiness |
| Example 6 | 7.14 | 0.03 | ◯ | 7.20 | 0.04 | ◯ |
| Comparative Example 6 | 13.45 | 7.3 | X | 13.72 | 7.5 | X |

1. A thermoforming mold having a surface roughness (Ra) of not more than 0.1μm.

2. A thermoformed article comprising a crystalline olefin resin, which article has a surface roughnesses (Ra) of not more than 3μm.

3. The thermoformed article according to claim 2, wherein the olefin resin contains a propylene homopolymer.

4. The thermoformed article according to claim 2, wherein the olefin resin contains a propylene homopolymier having an mmmm pentad % of not less than 0.95.

5. The thermoformed article according to claim 2, wherein the thermoformed article is a sheet having a thickness of from 50 to 700μm.

6. The thermoformed article according to claim 2, wherein the thermoformed article has a total haze of not more than 5% and an inner haze of not more than 3%.

7. A process for producing a thermoformed article, which comprises the steps of;
(i) heating and softening a crystalline olefin resin to obtain a sheet thereof; and
(ii) thermoforming the sheet with a thermoforming mole having a surface roughness (Ra) of not more than 0.1μm to obtain a thermoformed article having a surface roughness (Ra) of not more than 3μm.

8. The process for producing a thermoformed article according to claim 7, wherein the olefin resin contains a propylene homopolymer.

9. The process for producing a thermoformed article according to claim 7, wherein the olefin resin contains a propylene homopolymer having an mmmm pentad % of not less than 0.95.

10. The process for producing a thermoformed article according to claim 7, wherein the thermoformed article is a sheet having a thickness of from 50 to 700μm.

11. The process for producing a thermoformed article according to claim 7, wherein the thermoformed article has a total haze of not more than 5% and an inner haze of not more than 3%.

12. A laminated molding article. which comprises:
(i) a thermoformed article containing a crystalline olefin resin, and having a surface roughness (Ra) of not more than 3μm; and
(ii) a substrate containing a crystalline olefin resin.

13. The laminated molding article according to claim 12, wherein the olefin resin contains a propylene homopolymer.

14. The laminated molding article according to claim 12, wherein the olefin resin contains a propylene homopolymer having an mmmm pentad % of not less than 0.95.

15. The laminated molding article according to claim 12, wherein the thermoformed article is a sheet having a thickness of from 50 to 700μm.

16. The laminated molding article according to claim 12, wherein the thermoformed article has a total haze of not more than 5% and an inner haze of not more than 3%.

17. The laminated molding article according to claim 12, wherein the laminated molding article is a car part.

18. The laminated molding article according to claim 12, wherein the laminated molding article is a center cluster.

19. A process for producing a laminated molding article, which comprises the steps of:
(i) heating and softening a crystalline olefin resin to obtain a sheet thereof:
(ii) thermoforming the sheet with a thermoforming mold having a surface roughness (Ra) of not more than 0.1μm to obtain a thermoformed article having a surface roughness (Ra) of not more than 3μm;
(iii) setting the thermoformed article on a cavity side of a mold; and
(iv) injecting a molten crystalline olefin resin into the mold to obtain a laminated molding article, which contains the injected resin as a substrate and the thermoformed article bonded with the substrate.

20. The process for producing a laminated molding article according to claim 19, wherein the olefin resin contains a propylene homopolymer.

21. The process for producing a laminated molding article according to claim 19, wherein the olefin resin contains a propylene homopolymer having an mmmm pentad % of not less than 0.95.

22. The process for producing a laminated molding article according to claim 19, wherein the thermoformed article is a sheet having a thickness of from 50 to 700μm.

23. The process for producing a laminated molding article according to claim 19, wherein the thermoformed article has a total haze of not more than 5% and an inner haze of not more than 3%.

24. The process for producing a laminated molding article according to claim 19, wherein the laminated molding article is a car part.

25. The process for producing a laminated molding article according to claim 19, wherein the laminated molding article is a center cluster.
